(19) United States
(12) Patent Application Publication
(10) Pub. No.: US 2025/0194566 A1
(43) Pub. Date: Jun. 19, 2025

(54) LAY FLAT GRAB HANDLE FOR DOG RESTRAINT

(71) Applicant: 5.11, Inc., Manteca, CA (US)

(72) Inventors: John Thiet Ly, Lakewood, CA (US); Scott Robb Neilson, Colorado Springs, CO (US)

(21) Appl. No.: 18/986,561

(22) Filed: Dec. 18, 2024

Related U.S. Application Data
(60) Provisional application No. 63/611,428, filed on Dec. 18, 2023.

(51) Int. Cl. A01K 15/04; A01K 27/00

(52) U.S. Cl. CPC A01K 15/04; A01K 27/001; A01K 27/002; A01K 27/003

(57) ABSTRACT

A lay flat handle for a dog restraint includes an elastic strap and a handle strap. The elastic strap normally urges the handle strap into a lay flat position. A first end of the handle strap can be positioned under a first end of the elastic strap and a second end of the handle strap can be positioned under a second end of the elastic strap. The dog restraint can be a collar, a harness, or a leash. The lay flat handle can also be used in other applications.

### PRIORITY AND INCORPORATION BY REFERENCE

This application is related to and claims the benefit of U.S. Provisional Application No. 63/611,428, filed Dec. 18, 2023, titled LAY FLAT GRAB HANDLE FOR DOG RESTRAINT, the entirety of which is incorporated by reference herein and made a part of the present disclosure.

### BACKGROUND

### Field

The present disclosure generally relates to handles, which can be incorporated into dog restraint devices, such as dog harnesses, leashes, and collars. In particular, the present disclosure relates to a lay flat handle for dog harnesses, collars, and leashes.

### Description of Related Art

Handles for dog harnesses, leashes, and collars exist. However, there is a need for handles which can lay flat against the harness, leash, or collar, which address one or more shortcomings of the prior art and/or provide the public with a useful choice.

### SUMMARY

The systems, methods, and devices described herein have innovative aspects, no single one of which is indispensable or solely responsible for their desirable attributes. Without limiting the scope of the claims, some of the advantageous features will now be summarized.

In some aspects, the disclosure relates to a handle including an elastic strap and a handle strap. A first end of the handle strap is positioned under a first end of the elastic strap and a second end of the handle strap is positioned under a second end of the elastic strap.

In some configurations, the first end of the elastic strap is located on top of the first end of the handle strap and the second end of the elastic strap is located on top of the second end of the handle strap.

In some configurations, the handle strap includes a loop and the elastic strap passes through the loop.

In some configurations, the loop is formed by connecting a first edge of the handle strap to a second edge of the handle strap.

In some aspects, a length of the handle strap measured from the first end of the handle strap to the second end of the handle strap is greater than a length of the elastic strap measured from the first end of the elastic strap to the second end of the elastic strap.

In some configurations the handle strap is made of a flexible material.

In some configurations the handles strap is made of a flexible and inelastic material.

In some configurations the handle is attached to a surface.

In some aspects, the handle strap is attached to a surface and the handle strap sits flush to the surface when the elastic strap is relaxed.

In some aspects, the handle attaches to a curved surface and the handle strap sits flush to this surface when the elastic strap is relaxed.

In some aspects, the disclosure relates to a collar. The collar includes a strap and a handle connected to the strap. The handle has a handle strap which includes a first end connected to the strap, and a second end connected to the strap. The handle also includes an elastic strap comprising a first end connected to the strap and a second end connected to the strap.

In some configurations, the handle strap includes a first end connected to the strap, a second end connected to the strap, a first edge, a second edge opposite the first edge, and a loop formed by connecting a portion of the first edge to a portion of the second edge. The elastic strap passes through the loop.

In some aspects, the handle has a handle strap which includes a first end connected to the strap and a second end connected to the strap. The handle also includes an elastic strap comprising a first end connected to the strap above the first end of the handle strap and a second end connected to the strap above the second end of the handle strap.

In some configurations, the collar also includes a buckle configured to allow the strap to be closed into a loop and to open the loop. The buckle having a male connector attached to one end of the strap and a female connector attached to the other end of the strap.

In some configurations, the handle strap sits flush to the strap when the elastic strap is unstretched.

In some aspects, the strap is adjustable in length.

In some aspects, the collar also includes a tri-glide slide connected to the strap. In some aspects, the strap is made of nylon.

In some configurations, the collar also includes a second strap connected to the first strap.

In some aspects, the collar also includes a leash ring attached to the second strap.

In some configurations, the second strap is positioned under the handle.

In some configurations, the second strap is perpendicular to the strap.

In some aspects, the disclosure relates to a harness. The harness includes a first portion that is configured to wrap around the torso of a dog and a handle. The handle includes a handle strap and an elastic strap. The elastic strap comprises a first end connected to the strap and a second end connected to the strap.

In some configurations, the handle strap has a first end connected to the first portion, a second end connected to the first portion, a first edge, a second edge opposite the first edge, and a loop formed by connecting a portion of the first edge to a portion of the second edge. The elastic strap passes through the loop. In some configurations, the first end of the elastic strap is located on top of the first end of the handle strap and the second end of the elastic strap is located on top of the second end of the handle strap.

In some aspects, the handle includes a handle strap and an elastic strap. The handle strap has a first end connected to the first portion and a second end connected to the first portion. The elastic strap has a first end connected to the first portion below the first end of the handle strap and a second end connected to the first portion below the second end of the handle strap.

In some configurations, the first portion of the harness includes a first strap, a second strap attached to the first strap, and a buckle attached to the first strap. The buckle allows the strap to close into a loop and to open the loop.

In some configurations, the harness also comprises a second portion. The second portion includes a Y-shaped strap. The Y-shape strap has a first arm attached to the second strap of the first portion, a second arm attached to the second strap of the first portion, and a third arm attached to the first strap of the first portion.

In some aspects the buckle further comprises a male connector attached to the first strap and a female connector attached to the first strap.

In some aspects, the harness also includes a leash ring attached to the second strap.

In some configurations, the second strap sits under the handle.

In some aspects, the Y-strap further comprises a padded panel attached between the first, second, and third arms of the Y-shaped strap.

In some aspects, the first portion and the second portion are nylon.

In some aspects, the harness further comprises a first tri-glide slide connected to the strap.

In some aspects, the harness further comprises a first tri-glide slide connected to the first strap, a second tri-glide slide connected to the first arm of the Y-shaped strap, and a third tri-glide slide connected to the second arm of the Y-shaped strap.

In some aspects, the disclosure relates to a leash. The leash includes a first portion and a handle. The handle includes a handle strap and an elastic strap. The elastic strap comprises a first end connected to the first portion and a second end connected to the first portion.

In some configurations, the handle strap has a first end connected to the first portion, a second end connected to the first portion, a first edge, a second edge opposite the first edge, and a loop formed by connecting a portion of the first edge to a portion of the second edge. The elastic strap passes through the loop.

In some configurations, the first end of the elastic strap is located on top of the first end of the handle strap and the second end of the elastic strap is located on top of the second end of the handle strap.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings.

FIG. 1 is a perspective view of an embodiment of the handle incorporated into a dog harness.

FIG. 2 is a top view the dog harness of in FIG. 1.

FIG. 3 is a top view of the handle incorporated into a dog collar.

FIG. 4 is a top view of the handle shown separate from an associated object.

FIG. 5A is a side view of the handle in a lay flat position.

FIG. 5B is a side view of the handle in a lifted position.

### DETAILED DESCRIPTION

Handles attached to dog restraint devices, such as harnesses, collars, and leashes, are used to hold and control dogs. Often, dog harnesses and collars include a ring to attach a leash and a handle to hold onto the collar or harness itself. A design that connects a handle to the harness allows the dog's handler to control the dog without requiring the attachment of a leash to the harness. This is advantageous when the dog must perform off-leash tasks that require agility, such as shimmying under fences or running through underbrush. In these situations, leashes can snag, limiting the dog's mobility and putting the dog's safety at risk. Likewise, traditional handles can also snag, restrict the dog's mobility, and put the dog's safety at risk. A lay flat handle reduces the risk that the handle will snag while the dog performs agility tasks while still allowing the handler to control the dog when needed. The provision of a handle also provides the handler with another control point in addition to the leash. While the embodiments of the lay flat handle described herein often involve dog harnesses, collars, or leashes, the uses of the lay flat handle extend beyond the specifically described harnesses, collars, and leashes to other objects that conventionally have handles, or may benefit from a handle, in which a lay flat handle may be beneficial or desirable.

Embodiments of the lay flat handle will now be described with reference to the accompanying figures, wherein like numerals refer to like or similar elements throughout. Although several embodiments, examples, and illustrations are disclosed below, it will be understood by those of ordinary skill in the art that the inventions described herein extend beyond the specifically disclosed embodiments, examples, and illustrations, and can include other uses of the inventions and obvious modifications and equivalents thereof. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

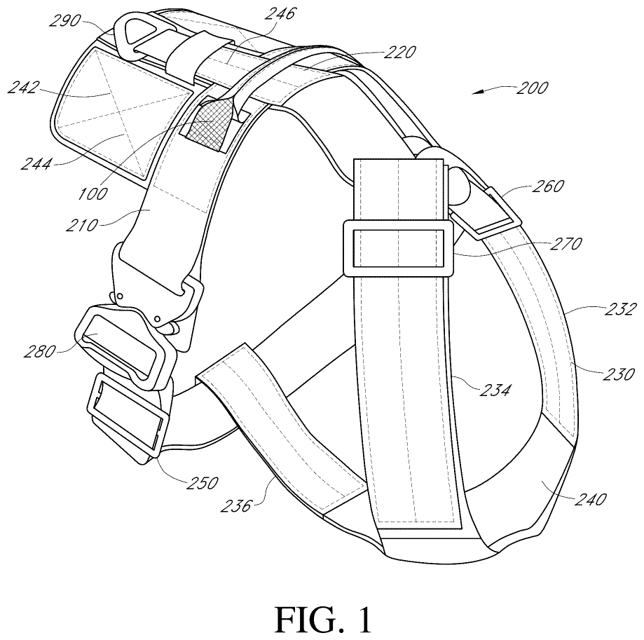

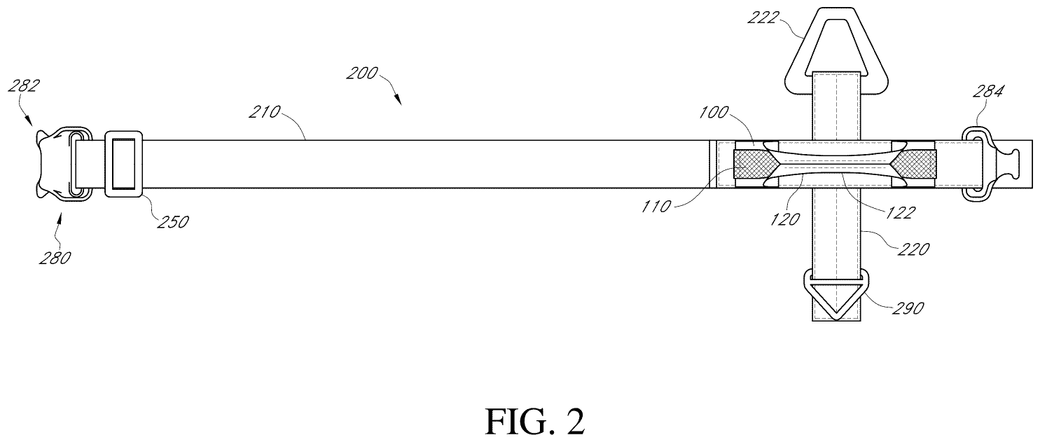

FIG. 1 illustrates an embodiment of the handle 100. FIG. 2 illustrates a top view of the handle 100 of FIG. 1. The handle 100 is shown in the context of an animal restraint, such as a dog restraint. As used herein, a restraint can be any device that can be attached to a dog, or other animal, and restricts the dog's movement. Examples of a dog restraint include a collar, a harness, and a leash. However, the handle 100 can be utilized with other objects, such as various types of bags, backpacks, luggage, or other objects having or benefitting from a handle.

FIG. 1 shows an embodiment of a handle 100, which can be incorporated into or otherwise configured to attach to a harness 200. The harness 200 generally includes a first portion configured to wrap around the torso of the dog and a second portion configured to wrap around the chest of the dog. In some embodiments, the harness 200 can comprise an additional portion (not shown) configured to wrap around the dog near the dog's belly. In the illustrated arrangement, the first portion includes a first strap 210 and a second strap 220. The second portion includes a Y-shaped strap 230.

A buckle 280 is attached to the first strap 210. The buckle 280 is configured to form the first strap 210 into a loop and to allow opening and closing of the loop. The buckle 280 may further include a female connector 282 and a male connector 284. In the illustrated arrangement, the handle 100 is attached to the first strap 210. A first tri-glide slide 250 is connected to the first strap 210. The second strap 220 is attached to the first strap 210, such as by a sewn connection. A leash ring 290 is attached to the second strap 220.

The Y-shaped strap 230 comprises a first strap portion or arm 232, a second strap portion or arm 234, a third strap portion or arm 236, and, optionally, a padded panel 240. The arms 232, 234, 236 extend from the padded panel 240 in a manner to form the Y-shape. The arms 232, 234, 236 can be connected to the padded panel 240 or the arms 232, 234, 236 can be connected to one another and the padded panel 240 can be connected to the arms 232, 234, 236 and can overlap one or both sides of the arms 232, 234, 236. The first arm 232 of the Y-shaped strap 230 can attach to the second strap 220. The second arm 234 of the Y-shaped strap 230 can also attach to the second strap 220. The third arm 236 of the Y-shaped strap 230 can attach to the first strap 210. In the illustrated arrangement, the third arm 236 attaches to the first strap 210 at a location spaced from the first arm 232 and the second arm 234. A second tri-glide slide 260 is connected to the first arm 232. A third tri-glide slide 270 is connected to the second arm 234.

In the illustrated arrangement, a panel 242 is attached to one or both of the first strap 210 and the second strap 220. A first loop panel 244 and a second loop panel 246 are connected to the panel 242. Each of the first loop panel 244 and the second loop panel 246 include a loop portion of a hook and loop fastener, which allows a patch, an accessory, or another suitable object to be coupled to the panel 242 using a hook portion of the hook and loop fastener. Although it is preferred for the loop material to be provided on the panel 242 for softness, in other arrangements, the loop material and the hook material can be reversed. Other releasable fastener types could also be used, with a first part of the fastener being provided on the panel 242 and a second part of the releasable fastener being provided on the patch, accessory, or other object.

FIG. 2 shows a top view of the first portion of the harness 200 of FIG. 1 in a laid flat orientation. The harness 200 may further include a connector ring 222 attached to the second strap 220. The connector ring 222 is configured to attach the first arm 232 and the second arm 234 of the Y-shaped strap 230 to the second strap 220. Accordingly, in the illustrated arrangement, the first arm 232 and the second arm 234 are directly connected to the second strap 220 and indirectly connected to the first strap 210 through the second strap 220. However, in other arrangements, the first arm 232 and the second arm 234 could be directly connected to the first strap 210.

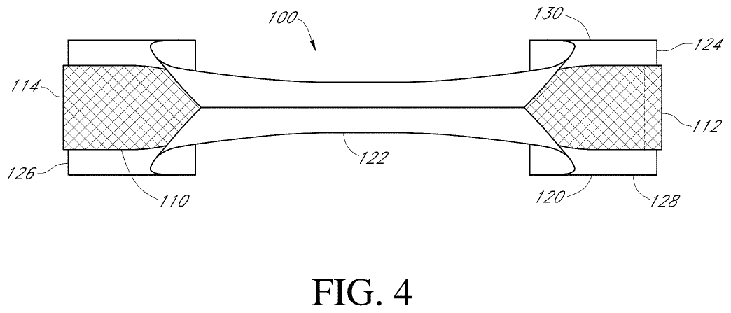

With additional reference to FIG. 4, the handle 100 can include an elastic element, such as an elastic strap or webbing 110 and a handle strap 120. The handle strap 120 can define a portion or an entirety of the surface that is grasped during use of the handle 100. The handle strap 120 can be non-clastic or substantially less clastic than the clastic webbing 110. The clastic webbing 110 can be at least twice as elastic, at least five times as elastic, or at least ten times as elastic as the handle strap 120. In the illustrated arrangement, an intermediate portion of the handle strap 120 forms a loop 122. The elastic webbing 110 passes through the loop 122. In the illustrated arrangement, the clastic webbing 110 sits on top of the handle strap 120 and passes through the loop 122. The ends of the handle strap 120 and the elastic webbing 110 lay flat and are connected to the first strap 210, such as by a sewn connection. The handle 100 may be positioned parallel relative to the first strap 210 and perpendicular relative to the second strap 220. However, this arrangement could be reversed and the handle 100 may be perpendicular relative to the first strap 210 and parallel relative to the second strap 220. The second strap 220 may be positioned to pass under the handle 100 between the two ends of the handle 100.

The harness 200 may be configured such that the first strap 210 fits around a dog's torso. The padded panel 240 will sit against the dog's chest. The first arm 232 and the second arm 234 will fit around the dog's neck. The third arm 236 extends from the padded panel 240 towards the dog's belly and connects to the bottom portion of the first strap 210. The handle 100 may be configured such that when the harness 200 is on a dog, the handle 100 is positioned on the dog's lower neck or upper back. In the illustrated arrangement, the handle 100 is positioned forward of the leash ring 290.

The first strap 210, second strap 220, and Y-shaped strap 230 may be made from nylon webbing, cloth, leather, canvas, or any suitable material. Any of these portions may be made from the same material or from different materials. The buckle 280, leash ring 290, connector ring 222, first tri-glide slide 250, second tri-glide slide 260, and third tri-glide slide 270 may be made from metal, plastic, or any suitable material. Any of these portions may be made from the same material or from different materials.

As discussed above, the Y-shaped strap 230 includes the first arm 232, the second arm 234, the third arm 236, and the padded panel 240. In some embodiments, the first arm 232, the second arm 234, the third arm 236, and the padded panel 240, or any combination thereof, may be formed as a single piece. The single piece can be an integrated assembly of several parts or can be formed as a unitary structure from a single piece of material.

In some embodiments, one or more of the first tri-glide slide 250, second tri-glide slide 260, and third tri-glide slide 270 may not be included. The tri-glide slides are included to allow for length adjustment of the respective strap. Alternatively, in some embodiments, other elements known in the art to adjust strap lengths may be substituted for one or all of the first tri-glide slide 250, second tri-glide slide 260, and third tri-glide slide 270. The third arm 236 can be configured to double over on itself and be connected to itself with a releasable fastener to form a desired length, such as a hook and loop fastener or other suitable two-piece fastener. This provides for length adjustment of the third arm 236 while allowing a tri-glide slide or other buckle to be omitted to provide improved comfort for the dog.

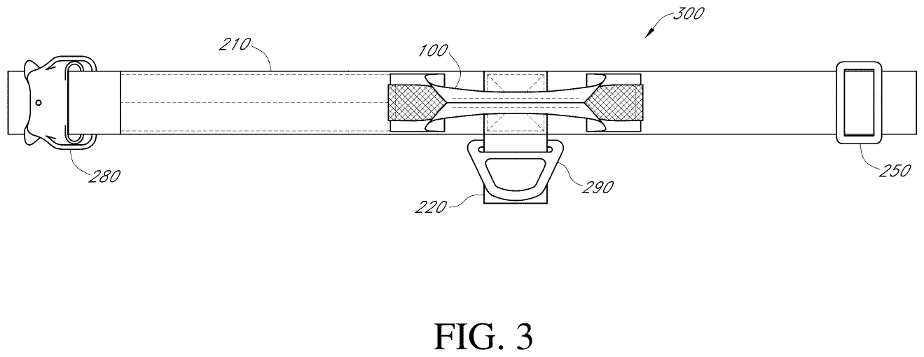

FIG. 3 illustrates another embodiment, in which the handle 100 can be configured to attach to or can be otherwise integrated into a collar 300. The illustrated collar 300 includes a first strap 210 and a second strap 220. A buckle 280 is attached to the first strap 210. The buckle 280 is configured to form the first strap 210 into a loop and to allow opening and closing of the loop. The handle 100 is attached to the first strap 210. A tri-glide slide 250 is connected to the first strap 210. The second strap 220 is attached to the first strap 210, such as by a sewn connection. A leash ring 290 is attached directly to the second strap 220 for indirect connection to the first strap 210. However, in other arrangements, the leash ring 290 could be directly attached to the first strap 210.

The collar 300 may be configured such that the first strap 210 fits a dog's neck. The handle 100 may be positioned parallel relative to the first strap 210 and perpendicular relative to the second strap 220. The second strap 220 may be positioned to sit under the handle 100.

The first strap 210 and second strap 220 may be made from nylon webbing, cloth, leather, canvas, or any suitable material. Any of these portions may be made from the same material or from different materials. The buckle 280, leash ring 290, and tri-glide slide 250 may be made from metal, plastic, or any suitable material. Any of these portions may be made from the same material or from different materials.

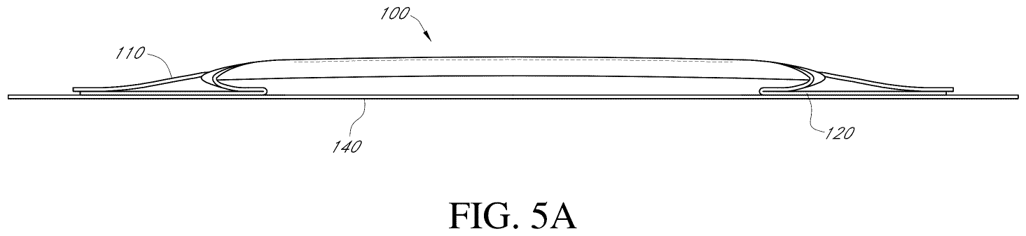

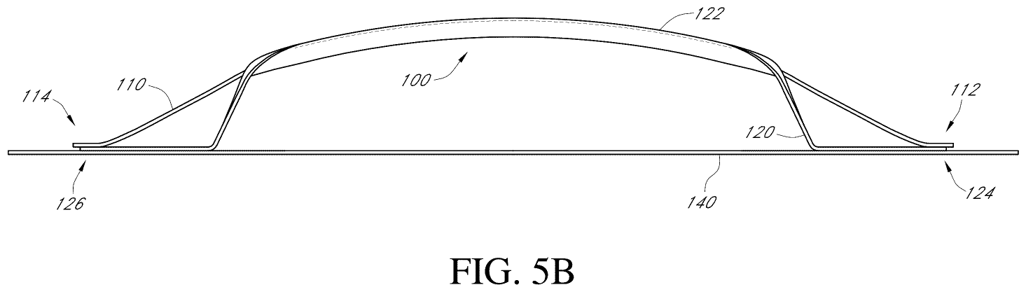

FIGS. 4, 5A, and 5B illustrate the handle 100 separate from the harness 200 or collar 300. As previously described, the handle 100 includes the clastic webbing 110 and the handle strap 120. The elastic webbing 110 comprises a first end 112 and a second end 114. In the illustrated arrangement, the elastic webbing 110 sits on top of or is positioned on the opposite side of the handle strap 120 relative to the object to which the handle 100 is attached. The positioning of the elastic strap 110 on top of the handle strap 120 improves the ability of the handle 100 to lay flat when not being used. The handle strap 120 includes the loop 122, a first end 124, a second end 126, a first edge 128, and a second edge 130 opposite the first edge 128. The first end 112 of the elastic webbing 110 is connected to, or relative to, the first end 124 of the handle strap 120. The second end 114 of the elastic webbing 110 is connected to, or relative to, the second end 126 of the handle strap 120. The elastic webbing 110 passes through the loop 122. In the illustrated arrangement, the loop 122 is formed by connecting a portion, such as an intermediate portion, of the first edge 128 to a corresponding portion of the second edge 130. The formation of the loop 122 creates a gripping surface for the handle strap 120 and protects the clastic strap 110 from damage. This arrangement allows the elastic strap 110 to sit on top of the handle strap 120 for an advantageous lay flat arrangement and inhibits or prevents a user from grasping the elastic strap 110. However, in some embodiments, the clastic webbing 110 could sit below the handle strap 120. Furthermore, the loop 122 could be formed by a separate piece that is connected to the handle strap 120.

FIG. 5A shows the handle 100 in a lay flat position. The elastic nature of the clastic strap 110 provides a force tending to shorten a length of the elastic strap 110, which urges the handle strap 120 towards the lay flat position. While in the lay flat position, the elastic webbing 110 is relaxed or more relaxed than in a lifted position of the handle 100. In the lay flat position, a portion or portions of the handle strap 120 can be folded under the clastic webbing. In the illustrated arrangement, each end of the handle strap 120 is configured to be folded when the handle 100 is in the lay flat position. The lay flat position places the loop 122 or the intermediate portion of the handle 100 relatively close to, or in contact with, a surface 140 of the object to which the handle 100 is attached, which can be the harness 200 or collar 300 for example, or could be a leash. In some arrangements, a space between the handle 100 and the surface 140 with the handle 100 in the lay flat position is too small for an adult to pass his or her hand through the space without lifting the handle 100. In some configurations, the space can have a height between the bottom of the handle 100 and the surface 140 of less than or equal to about one-half inch, one-quarter inch, or one-eighth inch. In some configurations, a portion or an entirety of the bottom of the handle 100 contacts the surface 140 and there is effectively no space. The rounded nature of the handle 100, due to the handle strap 120 forming the loop 122 or otherwise due to the handle 100 being formed with a rounded shape, allows a handler to slide his or her fingers underneath the handle 100 while in the lay flat position to move the handle 100 away from the lay flat position, towards the lifted position, such that the handler can grasp the handle 100.

FIG. 5B shows the handle 100 in the lifted position. The first end 112 of the elastic webbing 110, the first end 124 of the handle strap 120, the second end 114 of the elastic webbing 110, and the second end 126 of the handle strap 120 are all connected to the surface 140. While in the lifted position, the elastic webbing 110 is stretched to allow the handle strap 120 to unfold. The lifted position separates the bottom of the loop 122 from the surface 140.

The elastic webbing 110 may be made, in whole or in part, from a number of elastic materials including but not limited to natural rubber or synthetic rubber, such as an elastomeric material. The entire length of the clastic webbing 110 need not be elastic. Instead, any sufficient portion of the elastic webbing 110 can be elastic or stretchable to provide for suitable movement of the handle strap 120 or the handle 100. For example, in an alternative arrangement, only a portion of the elastic webbing 110 within the loop 122 may be stretchable. The handle strap 120 may be made from a flexible material. The handle strap 120 may be made from nylon webbing, cloth, leather, canvas, or any suitable material. The loop 122 may be formed from the handle strap 120. Alternatively, the loop 122 may be separately attached to the handle strap 120. In some embodiments, the handle strap 120 does not comprise a loop 122, instead, the handle strap 120 is connected (e.g., sewn, riveted, or glued) to the elastic webbing 110 in one or more places.

In some embodiments, the handle strap 120 is made from a flexible but inelastic material. The flexible but inelastic material limits the extent of the lifted position depending on the length of the handle strap 120.

In some embodiments, the clastic strap 110 takes the form of a flat strap. In other embodiments, the elastic strap 110 takes the form of an elastic band, an elastic cord, or any other suitable shape.

In some embodiments, the lay flat position of the handle 100 is understood to be flush to a contoured or curved shape of the first strap 210 when in use on a dog harness or dog collar. In other embodiments, the lay flat position of the handle 100 is understood to be substantially planar. The shape of the handle strap 120 or other elements of the handle 100 can determine the shape of the handle in either or both of the lay flat position and the lifted position.

### CONCLUSION

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

What is claimed is:

1. A handle for a dog restraint, comprising:
an elastic strap; and
a handle strap wherein a first end of the handle strap is positioned under a first end of the elastic strap and a second end of the handle strap is positioned under a second end of the elastic strap.

2. The handle of claim 1, wherein the handle strap comprises a loop, and the elastic strap passes through the loop.

3. The handle of claim 2, wherein the loop is formed by connecting a first edge of the handle strap to a second edge of the handle strap.

4. The handle of claim 1, wherein a length of the handle strap measured from the first end of the handle strap to the second end of the handle strap is greater than a length of the elastic strap measured from the first end of the elastic strap to the second end of the elastic strap with each of the handle strap and the elastic strap in a laid flat position.

5. The handle of claim 1, wherein the elastic strap is configured to urge the handle strap towards a surface of the dog restraint to which the handle is attached.

6. A dog restraint, comprising:
a strap; and
a handle, comprising:
a handle strap, comprising:
a first end connected to the strap;
a second end connected to the strap; and
an elastic strap comprising a first end connected to the strap and a second end connected to the strap.

7. The dog restraint of claim 6, wherein the handle strap further comprises:
a first edge;
a second edge; and
a loop formed by connecting a portion of the first edge to a portion of the second edge;
wherein, the first end of the elastic strap is connected to the strap on top of the first end of the handle strap and the second end of the elastic strap is connected to the strap on top of the second end of the handle strap, and wherein the elastic strap passes through the loop.

8. The dog restraint of claim 6, wherein the first end of the elastic strap is connected to the strap on top of the first end of the handle strap and the second end of the elastic strap is connected to the strap on top of the second end of the handle strap.

9. The dog restraint of claim 6, further comprising a buckle configured to allow the strap to be closed into a loop and to open the loop, the buckle further comprising a male connector attached to one end of the strap and a female connector attached to an other end of the strap.

10. The dog restraint of claim 9, wherein the strap is adjustable in length.

11. The dog restraint of claim 6, further comprising a tri-glide slide connected to the strap.

12. The dog restraint of claim 6, wherein the strap is nylon.

13. The dog restraint of claim 6, further comprising a second strap connected to the strap.

14. The dog restraint of claim 13, further comprising a leash ring attached to the second strap.

15. The dog restraint of claim 13, wherein the second strap is positioned under the handle.

16. The dog restraint of claim 13, wherein the second strap is perpendicular to the strap.

17. The dog restraint of claim 6, wherein the dog restraint is a collar, a harness, or a leash.
